(19) United States
(12) Patent Application Publication
(10) Pub. No.: US 2023/0391379 A1
(43) Pub. Date: Dec. 7, 2023

(54) SAND RAIL CAR MODULARIZED LENGTHENING MODIFICATION PROGRAMS AND RAILCARS FORMED THEREBY

(71) Applicant: JAC Operations, Inc., Chicago, IL (US)

(72) Inventors: Gregory P. Josephson, Salix, PA (US); Michael H. Kress, Armagh, PA (US); Ethan Ryan Terrell, Danville, AL (US); Kerry Sauter, SIDMAN, PA (US)

(21) Appl. No.: 18/207,747

(22) Filed: Jun. 9, 2023

Related U.S. Application Data
(63) Continuation of application No. PCT/US21/62677, filed on Dec. 9, 2021.
(60) Provisional application No. 63/123,150, filed on Dec. 9, 2020.

(51) Int. Cl. B61D 7/02

(52) U.S. Cl. CPC B61D 7/02

(57) ABSTRACT

A sand car modification program including removing a center section at cut-lines between the trucks and maintaining two repurposed end sections for the modified railcar. Each end section including a center sill section, side sill sections; top chord sections, side wall sections, and a sloped end floor section extending between the pair of side wall sections and extending down at least to the pair of side sill sections. An underframe construction of the modified railcar is formed between the repurposed end sections, including a center sill construction coupled to the end section center sill sections, a plurality of hopper gate openings, and at least one hopper divider. A pair of sidewall constructions are formed between the end sections, each including a side sill section, a top chord section, and a side wall section.

### RELATED APPLICATIONS

This application is a continuation of International Application Serial Number PCT/US2021/062677 filed Dec. 9, 2021 and which published Jun. 16, 2022 as WO 2022/125818. International Application Serial Number PCT/US2021/062677 claims the benefit of U.S. Provisional Patent Application Ser. No. 63/123,150, filed Dec. 9, 2020, titled “Sand Rail Car Modularized Lengthening Modification Programs and Railcars Formed Thereby.” The above applications and publication are incorporated herein by reference in their entirety.

### BACKGROUND OF THE INVENTION

### 1. Field of the Invention

The present invention relates to railroad car modifications, and more particularly to a sand car modularized lengthening modification programs and the railcars formed thereby.

### 2. Background Information

In the railroad art, rolling stock has become very specialized with cars specific for transporting automobiles (vehicle carriers), shipping containers (well cars), bulk commodities open top gondola for hauling coal, ballast, coke, wood chips, ore, sand, scrap metal and construction debris, and aggregate, bulk commodities closed top hoppers for hauling grain, sand, cement, potash, soda ash, DDG, and roofing granules, bulk commodities open top hoppers for products similar to open top gondola, tanker cars and more. Railcars typically have a very long useful life of 50+ years of potential service. However, due to changes in the marketplace there can be a large surplus of a given car type. Additionally, the efficiency of newer car types might make a prior car type obsolete before the end of the useful life of the railcar.

For example currently in the United States there is currently a surplus of “sand railcars” defined herein as those originally built primarily for hauling sand and other high density dry bulk products. The boom of the frac industry resulted in a large increase in the rail shipment of specialized sand, known as frac sand. As late as May 2018 the periodical RAILWAY AGE reported that “In the nonmetallic minerals market, an executive supplying the energy industry described the demand by drillers for fracking sand as “insatiable,” adding that only operations issues with Class I railroads was holding back even greater shipment volumes.” The railcar industry responded with an increase in the available sand rail cars. A drastic increase in available sand rail cars was met with a similarly drastic decrease in need from frac industry, leading to fleets of underutilized sand rail cars.

It has been known to repurpose or modification of an older surplus or obsolete car type into a car type that has greater current utility. “Modification” is Association of American Railroads (AAR) defined term (see Office Manual of the AAR Interchange Rules, rule 88(d)(2)) defined as a change to a car that alters capacity of car, or size of car type, or type of lading being hauled. This application uses the terms modification and modify in connection with this rule whereby within this application rail car modification programs reference programs that will modify railcars within the meaning of this AAR rule.

The applicants successfully developed a coal car related modification program that is described in WO 2019/191762, which is incorporated herein by reference. The modification program set forth in the '762 application may be effectively adapted to sand cars, however there may be more efficient methodologies minimizing scrap and maximizing repurposed components as applied to sand cars.

U.S. Pat. Nos. 6,502,518 and 5,181,474 and U.S. Patent Application Publication No. 2011/0226153 are also of general interest as background to the present disclosure.

There is a need for effective and efficient modification methodologies for sand rail cars in particular and the present invention is primarily related to sand car modularized lengthening modification programs and the railcars formed thereby.

### SUMMARY OF THE INVENTION

It is an object of the present invention to provide an effective and efficient modification method and associated cast components for sand car modularized lengthening modification programs and the railcars formed thereby.

One aspect of the invention provides a method of modification of a railcar which includes providing an existing railcar, such as a sand car, with a plurality of hoppers supported on a pair of trucks, with the laterally end hoppers including sloped end floors; removing a center section of the existing railcar at cut-lines between the trucks and maintaining two repurposed end sections for the modified railcar, each end section including a center sill section, a pair of side sill sections; a pair of top chord sections, a pair of side wall sections with each side wall section extending between a side sill section and a top chord section, and a sloped end floor section extending between the pair of side wall sections and extending down at least to the pair of side sill sections; forming an underframe construction of the modified railcar between the repurposed end sections, wherein the underframe construction includes a center sill construction coupled to the center sill sections of each repurposed end section, a plurality of hopper gate openings between the repurposed end sections, and at least one hopper divider between the repurposed end sections; and forming a pair of sidewall constructions of the modified railcar between the repurposed end sections, wherein each sidewall construction includes a side sill section coupled to one of the side sill sections of each repurposed end section; a top chord section coupled to one of the top chord sections of each repurposed end section, a side wall section extending between the side sill section and the top chord section.

Another aspect of the present invention is a method of modification of a railcar to form a modified railcar comprising the steps of providing an existing railcar with longitudinal structural members comprising a center sill, a pair of side sills and a pair of top chords and a pair of trucks; cutting the structural members along at least one cut line between the pair of trucks and maintaining two repurposed end sections for the modified railcar, each end section including a center sill section, a pair of side sill sections and a pair of top chord sections; and aligning and coupling the longitudinal structural members of the two repurposed end sections for the modified railcar, wherein the coupling of at least one of the structural members includes the steps of providing internal backing bars within the structural member matching the interior of the structural member and providing a full depth weld through the structural members along substantially the full perimeter thereof.

Another aspect of the invention is the railcar formed with the modification programs according to the present invention.

These and other advantages of the present invention will be clarified in the brief description of the preferred embodiment taken together with the drawings in which like reference numerals represent like elements throughout.

### BRIEF DESCRIPTION OF THE DRAWINGS

FIG. 1 is a schematic perspective view of an existing two hopper sand car acting as a donor car in a sand car modularized lengthening modification program according to one embodiment of the present invention.

FIG. 2 is a schematic perspective view of repurposed end sections of the railcar of FIG. 1 in a sand car modularized lengthening modification program according to one embodiment of the present invention.

FIG. 3 is a schematic perspective view of an underframe construction of the modified railcar between the repurposed end sections of the railcar of FIG. 1 in a sand car modularized lengthening modification program according to one embodiment of the present invention.

FIGS. 4A and B are schematic perspective views of sidewall construction of the modified railcar between the repurposed end sections of the railcar of FIG. 1 in a sand car modularized lengthening modification program according to one embodiment of the present invention.

FIG. 5 is a schematic perspective view of roof and coaming construction of the modified railcar between the repurposed end sections of the railcar of FIG. 1 in a sand car modularized lengthening modification program according to one embodiment of the present invention.

FIG. 6 is a schematic perspective view of the final modified railcar in a sand car modularized lengthening modification program according to one embodiment of the present invention.

FIG. 7A is a schematic perspective view of a center sill splice contoured backing bar for a roll formed center sill for use in a sand car modularized lengthening modification program according to one embodiment of the present invention.

FIG. 7B is a schematic end view of the center sill splice contoured backing bar for the roll formed sill of FIG. 7A.

FIG. 7C is a schematic isolation perspective view of the center sill splice contoured backing bar for a roll formed sill of FIG. 7A.

FIG. 8A is a schematic perspective view of a center sill splice contoured backing bar for a hot rolled center sill section for use in a sand car modularized lengthening modification program according to one embodiment of the present invention.

FIG. 8B is a schematic end view of the center sill splice contoured backing bar for a hot rolled center sill section of FIG. 8A.

FIG. 8C is a schematic isolation perspective view of the center sill splice contoured backing bar for the hot rolled sill section of FIG. 8A.

FIG. 9A is a schematic perspective view of a center sill splice contoured backing bar for a fabricated center sill section for use in a sand car modularized lengthening modification program according to one embodiment of the present invention.

FIG. 9B is a schematic end view of the center sill splice contoured backing bar for a fabricated center sill section of FIG. 9A.

FIG. 9C is a schematic isolation perspective view of the center sill splice contoured backing bar for the fabricated center sill section of FIG. 9A.

FIG. 10A is a schematic perspective view of a top chord splice contoured backing bar for a top chord section for use in a sand car modularized lengthening modification program according to one embodiment of the present invention.

FIG. 10B is a schematic perspective view of a side sill splice contoured backing bar for a side sill section for use in a sand car modularized lengthening modification program according to one embodiment of the present invention.

### DESCRIPTION OF THE PREFERRED EMBODIMENTS

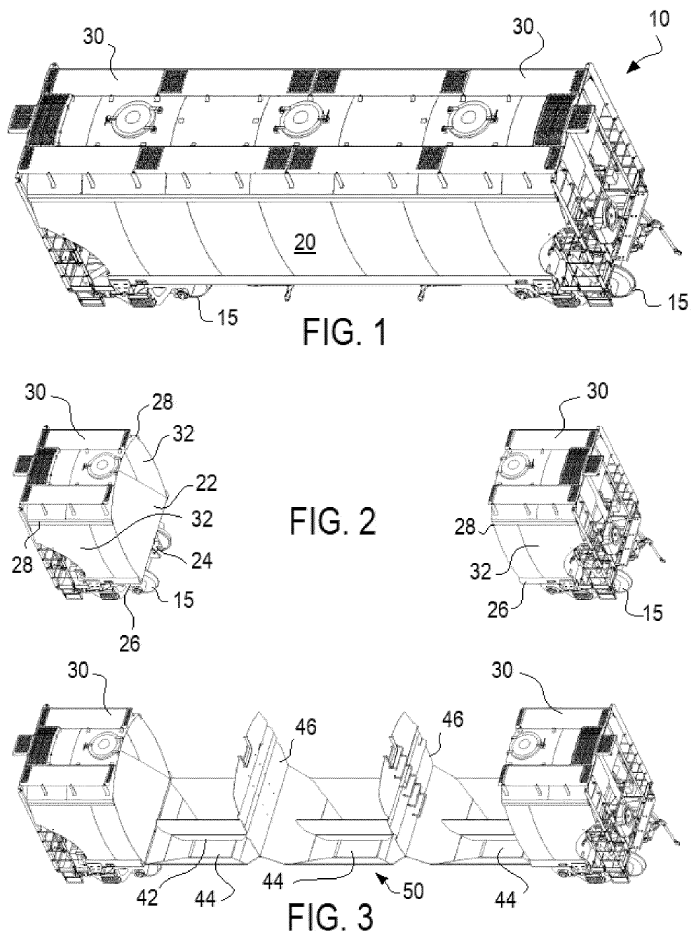

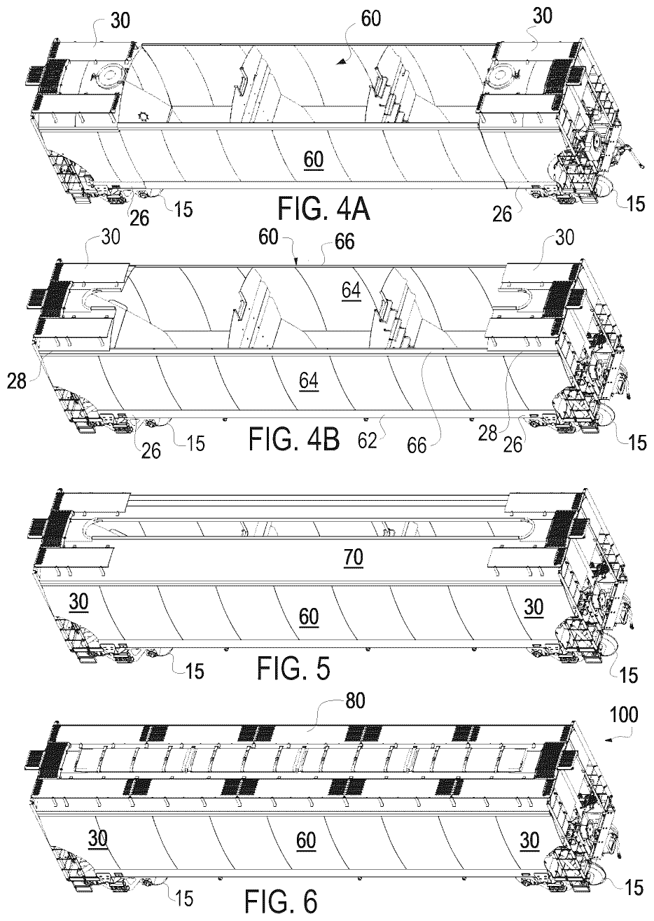

The present invention provides a sand car 10 modularized lengthening modification programs and the railcars 100 formed thereby. In summary the method of modification of a railcar 10 to form a modified railcar 100 can be described as comprising the steps of i) providing an existing railcar 10 with a plurality of hoppers supported on a pair of trucks 15, with the laterally end hoppers including sloped end floors 22, such as a sand car 10 shown in FIG. 1; ii) removing a center section 20 of the existing railcar 10 at cut-lines between the trucks 15 and maintaining two repurposed end sections 30 for the modified railcar such as shown in FIG. 2, each end section including a center sill section 24, a pair of side sill sections 26; a pair of top chord sections 28, a pair of side wall sections 32 with each side wall section 32 extending between a side sill section 26 and a top chord section 28, and a sloped end floor section 22 extending between the pair of side wall sections 32 and extending down at least to the pair of side sill sections 26; iii) forming an underframe construction 50 of the modified railcar 100 between the repurposed end sections 30 such as shown at FIG. 3, wherein the underframe construction includes a center sill construction 42 coupled to the center sill sections 24 of each repurposed end section 30, a plurality of hopper gate openings 42 between the repurposed end sections 30, and at least one hopper divider 46 between the repurposed end sections 30; and iv) forming a pair of sidewall constructions 60 of the modified railcar 100 between the repurposed end sections 30 such as shown in FIGS. 4A and 4B, wherein each sidewall construction 60 includes a side sill section 62 coupled to one of the side sill sections 26 of each repurposed end section 30; a top chord section 66 coupled to one of the top chord sections 28 of each repurposed end section 30, a side wall section 64 extending between the side sill section 62 and the top chord section 66. Where the modified railcar 100 is a covered hopper car the method further includes the steps of forming roof 70 and coaming construction 80 of the modified railcar 100 between the repurposed end sections 30 of the railcar as shown in FIGS. 5 and 6 to form the modified railcar 100 of FIG. 6.

The present invention is directed to sand car modification programs and sand cars 10 can be defined as cars with a plurality of hoppers, generally two, supported on a pair of trucks 15, with the laterally end hoppers including sloped end floors 22 extending to hopper gates. Hopper divider structures separate the hoppers. As there are a surplus of two hopper railcars 10 in existing fleets the present modification is lengthening these cars 10 to be three hopper grain type cars 100. However the principles of the present invention may be used for modifying any surplus hopper car and could result in shortening of the modified car from the donor car without changing the principles of the present modification program. As background the trucks 15, center sill, draft arm assemblies, couplers, brake assembly and controls, collectively represent considerable cost components of any railcar and the reuse of some or all of these components makes railcar modification, in general, feasible, provided, as in the present invention, there is not too much work associated with conforming the prior existing components to the end design. The trucks 15 will generally be the same in a rebuilt or modified car 100 and are easily repurposed.

Turning to FIG. 2, one important aspect of the present modification program is removing a center section 20 of the existing railcar 10 at cut-lines between the trucks 15 and maintaining two repurposed end sections 30 for the modified railcar 100. The end sections 30 incorporate the critical repurposed components of the modified railcar 100 and have them already assembled. The end sections 30 also define the profiles of the structural components, namely the center sill, the side sills and the top chords. The end sections 30 further define the position and shape of the side walls and the roof for the modified railcar 100. The end sections 30 will also maintain the end sills and the end wall structure, including the sloped end floor plates 22.

Each end section 30 includes a center sill section 24. The center sill of a railcar is the primary structural member of the underframe of a rail car, and this is true in the modified railcar 100. The center sill of a railcar, such as modified railcar 100, is subjected to the buff and draft forces created during operation of the railcar and extends as a continuous member along the length of the car body. Center sills in expected donor cars 10 may possess several different configurations generally categorized herein by the forming process, such as a cold formed center sill, a hot rolled center sill and a fabricated center sill. In a modification of a railcar 10 to a new car type, as in the present invention forming railcar 100, it is common and generally required to adjust the length of the center sill to the new car length configuration as a critical step. In the end sections 30, the center sill section 24 of at least one section 30 may extend further than the remaining portions of the end section 30 to maximize the repurposed center sill. In fact it is possible that the entire original center sill section is repurposed and the entire two portions 24 of the original center sill remain attached to the two ends 30 (with a new portion being added for the extra length). For example, in the modified car 100 the original center sill as portions 24 may transverse the end hoppers of the modified car 100 with a transition piece or center sill 42 traversing the central hopper.

Each end section 30 includes a pair of side sill sections 26. In railcars in general, and in the donor car 10 and the modified car 100 of the invention in particular, the side sills run along sides of the underframe and provide structural integrity to the car and reinforce the center sill.

Each end section 30 includes an end top chord and a pair of top chord sections 28. In railcars in general, and specifically in the donor car 10 and the modified car 100 of the invention, the top chords and end top chords run along the top edge of the side walls and end walls, and may include corner caps between the end top chord and the top chords and provide structural integrity to the car and the side walls.

Each end section 30 also includes a pair of side wall sections 32 with each side wall section 32 extending between a side sill section 26 and a top chord section 28.

As noted above, each end section 30 includes a sloped end floor section 22 extending between the pair of side wall sections 32 and extending down at least to the pair of side sill sections 26. The end section 30 may have the end floor section 22 extend past the side sills 26 toward the gate opening 44, but having this section 22 extend at least to the side sills 26 is believed to yield structural integrity to the cut end section 30 and facilitate the modification.

The end sections 30 are placed at the appropriate distance for the modified railcar 10, generally farther apart than these portions are found in the original donor sand car 10. With the end sections 30 placed in a desired spaced position, the method includes forming an underframe construction 50 of the modified railcar 100 between the repurposed end sections 30 such as shown at FIG. 3. The formed underframe construction 60 includes a center sill construction 42 coupled to the center sill sections 24 of each repurposed end section 30, a plurality of hopper gate openings 44 between the repurposed end sections 30, and at least one hopper divider 46, although more commonly or preferably two hopper dividers 46 between the repurposed end sections 30.

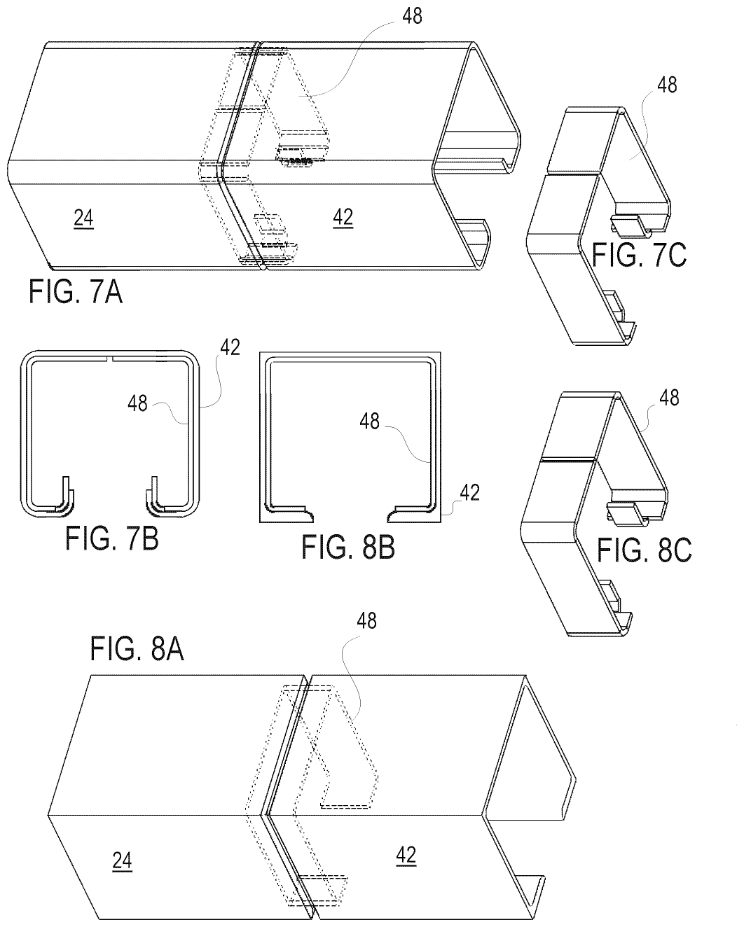

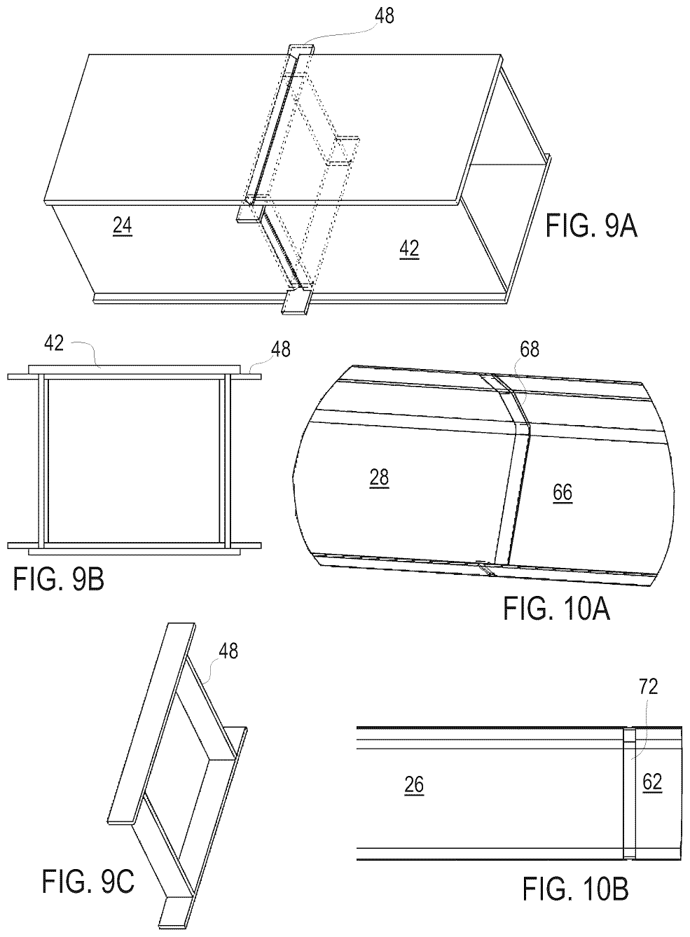

The coupling of the center sill construction 42 of the formed underframe 50 to the center sill sections 24 of the end sections 30 may be through AAR patch couplings, or more preferably through lightweight transition type or splice type castings similar to those described in WO 2019/191762, which publication is incorporated herein by reference. Additionally, the coupling of the center sill construction 42 of the formed underframe 50 to the center sill sections 24 of the end sections 30 may be through the use of center sill splice contoured backing bar 48 such as shown in FIGS. 7A-C for a cold rolled center sill, 8A-C for a hot rolled center sill and FIGS. 9A-C for a fabricated center sill. The castings or the backing bars 48 are the preferred methods of coupling the center sill construction 42 of the formed underframe 50 to the center sill sections 24 of the end sections 30 in the modified railcar 100.

When using the backing bars 48 for coupling the center sill construction 42 of the formed underframe 50 to the center sill sections 24 of the end sections 30 the method includes aligning and coupling the center sill sections 24 of the two repurposed end sections 30 for the modified railcar 100 with the intervening center sill section 42 (and with each other). The internal backing bars 48 are provided within the center sill section 24 matching the interior of the structural member which allows for providing a full depth weld through the center sill section 24 along substantially the full perimeter thereof. The coupling with the backing bars 48 may further include overlaying patches, which may allow for compliance with existing AAR splicing protocols, but the patches are not believed to be required for the modified railcar 100 performance. In the backing bar 48 for the fabricated sill shown in FIGS. 9A-C, one of ordinary skill in the art would understand that the associated center sill components 24 and 42 being joined will be notched to accept the backing bar 48 configuration and the extra portions thereof (those “sticking out”) will be removed (burned off) after coupling. The coupling with the backing bars 48 of the present invention has utility outside of the modification program of the present invention and represents an improved center sill splicing approach.

The underframe construction 50 of the modified railcar 100 includes forming a plurality of hopper gate openings 44 between the repurposed end sections 30. It is likely that new gates will be associated with the modified railcar 100 that are associated with grain car type laden and these may have a different opening size and end floor sheet slope associated therewith than in the original sand car or donor car 10. It is also possible that the original gates from the donor car 10 may be repurposed. In general the dividers 46 and gates for openings 44 are formed in a conventional fashion.

There is an alternative arrangement in which a divider is repurposed from the donor car 10 and this would include two additional cut lines on either side of the divider from the donor car 10 and would yield an intervening divider section that would include its own center sill section, pair of side sill sections; pair of top chord sections, pair of side wall sections with each side wall section extending between a side sill section and a top chord section. The divider section will have its own center sill section, pair of side sill sections; pair of top chord sections, pair of side wall sections with each side wall section spliced into the modified railcar 100 in the same manner as the end section 30 components. The repurposing of the divider with the additional cut lines would need to be balanced with the additional couplings that would be required

Following the forming an underframe construction 50 of the modified railcar 100 is the step of forming of a pair of sidewall constructions 60 of the modified railcar 100 between the repurposed end sections 30 such as shown in FIG. 4.

Each sidewall construction 60 includes a side sill section 62 coupled to one of the side sill sections 26 of each repurposed end section 30. The coupling of the side sill section 62 to one of the side sill sections 26 of each repurposed end section 30 may be through the use of side sill splice contoured backing bar 72 such as shown in FIG. 10B. The internal backing bars 72 are provided within the side sill sections 26 and 62 matching the interior of the structural member which allows for providing a full depth weld through the side sill sections 62 and 26 along substantially the full perimeter thereof.

Similarly, each sidewall construction 60 includes a top chord section 66 which is coupled to one of the top chord sections 28 of each repurposed end section 30, wherein the coupling of the top chord section 66 to one of the top chord sections 28 of each repurposed end section 30 may be through the use of top chord splice contoured backing bar 68 such as shown in FIG. 10A. The internal backing bars 68 are provided within the top chord sections 28 and 66 matching the interior of the structural member which allows for providing a full depth weld through the side sill sections 28 and 66 along substantially the full perimeter thereof.

The sidewall constructions 60 include side sheets 64 extending between the top chord section 66 and the side chord section 62 and formed in a conventional fashion. The side sheets 64 may be attached to adjacent side sheets 32 of the end sections 30 through an overlapping plate or side stake, or a patch or via direct welding.

Where the modified railcar 100 is a covered hopper car, the method further includes the steps of forming roof 70 and coaming construction 80 of the modified railcar 100 between the repurposed end sections 30 of the railcar 100 as shown in FIGS. 5 and 6 to form the modified railcar 100 of FIG. 6. The roof 70 and coaming 80 structures are conventional and determined by the final car design although the end sections 30 do define the general shape for these elements. The present invention is not limited to forming covered hopper cars 100 and could be used to form an open top car 100. However the preferred method uses a two hopper covered hopper sand car 10 and converts to a three hopper covered hopper grain car 100 as shown.

Further the present invention can utilize a stub sill hopper car 10 as the donor car 10 and convert the same to the through sill hopper car 100 as shown. In this configuration a transition casting coupling to transition from the stub sill (24) to the center sill section 42 would be preferably be used.

Although the present invention has been described with particularity herein, the scope of the present invention is not limited to the specific embodiment disclosed. It will be apparent to those of ordinary skill in the art that various modifications may be made to the present invention without departing from the spirit and scope thereof. The scope of the present invention should be defined by the appended claims and equivalents thereto.

What is claimed is:

1. A method of modification of a railcar to form a modified railcar comprising the steps of:
providing an existing railcar with a plurality of hoppers supported on a pair of trucks, with the laterally end hoppers including sloped end floors;
removing a center section of the existing railcar at cut-lines between the trucks and maintaining two repurposed end sections for the modified railcar, each end section including a center sill section, a pair of side sill sections; a pair of top chord sections, a pair of side wall sections with each side wall section extending between a side sill section and a top chord section;
forming an underframe construction of the modified railcar between the repurposed end sections, wherein the underframe construction includes a center sill construction coupled to the center sill sections of each repurposed end section, a plurality of hopper gate openings between the repurposed end sections, and at least one hopper divider between the repurposed end sections; and
forming a pair of sidewall constructions of the modified railcar between the repurposed end sections, wherein each sidewall construction includes a side sill section coupled to one of the side sill sections of each repurposed end section; a top chord section coupled to one of the top chord sections of each repurposed end section, a side wall section extending between the side sill section and the top chord section.

2. The method of modification of a railcar according to claim 1, wherein each repurposed end sections includes a sloped end floor section extending between the pair of side wall sections and extending down at least to the pair of side sill sections.

3. The method of modification of a railcar according to claim 2, further including the step of forming a roof section between the repurposed end sections matching roof sections of each repurposed end section.

4. The method of modification of a railcar according to claim 3, wherein the coupling of the center sill construction the center sill sections of each repurposed end section comprises providing internal backing bars matching the interior of the center sill sections of each repurposed end section and providing a full depth weld through the center sill section along substantially the full perimeter thereof.

5. The method of modification of a railcar according to claim 4, wherein the coupling of the center sill construction the center sill sections of each repurposed end section comprises providing overlaying exterior patches.

6. The method of modification of a railcar according to claim 3, wherein the coupling of each sidewall construction side sill section comprises providing internal backing bars matching the interior of the side sill sections of each repurposed end section and providing a full depth weld through the side sill section along substantially the full perimeter thereof.

7. The method of modification of a railcar according to claim 3, wherein the coupling of each sidewall construction top chord section comprises providing internal backing bars matching the interior of the top chord sections of each repurposed end section and providing a full depth weld through the top chord section along substantially the full perimeter thereof.

8. A railcar formed by the method of modification of a railcar of claim 1.

9. The railcar according to claim 8 further including internal backing bars matching the interior of the center sill sections of each repurposed end section.

10. The railcar according to claim 9 further including internal backing bars matching the interior of the side sill sections of each repurposed end section.

11. The railcar according to claim 10 further including internal backing bars matching the interior of the top chord sections of each repurposed end section.

12. A method of modification of a railcar to form a modified railcar comprising the steps of:
providing an existing railcar with longitudinal structural members comprising a center sill, a pair of side sills and a pair of top chords and a pair of trucks;
cutting the structural members along at least one cut line between the pair of trucks and maintaining two repurposed end sections for the modified railcar, each end section including a center sill section, a pair of side sill sections and a pair of top chord sections;
aligning and coupling the longitudinal structural members of the two repurposed end sections for the modified railcar, wherein the coupling of at least one of the structural members includes the steps of providing internal backing bars within the structural member matching the interior of the structural member and providing a full depth weld through the structural members along substantially the full perimeter thereof.

13. The method of modification of a railcar according to claim 12, wherein the existing railcar includes a plurality of hoppers supported on the pair of trucks, with the laterally end hoppers including sloped end floors.

14. The method of modification of a railcar according to claim 13, wherein each repurposed end sections further includes a pair of side wall sections with each side wall section extending between one of the side sill sections and one of the top chord sections, and a sloped end floor section extending between the pair of side wall sections and extending down at least to the pair of side sill sections.

15. The method of modification of a railcar according to claim 14, wherein the cutting the structural members includes removing a center section of the existing railcar at cut-lines between the trucks and maintaining the two repurposed end sections for the modified railcar.

16. The method of modification of a railcar according to claim 15, wherein the aligning and coupling the longitudinal structural members includes the step of forming an underframe construction of the modified railcar between the repurposed end sections, wherein the underframe construction includes a center sill construction coupled to the center sill sections of each repurposed end section, a plurality of hopper gate openings between the repurposed end sections, and at least one hopper divider between the repurposed end sections.

17. The method of modification of a railcar according to claim 16, wherein the aligning and coupling the longitudinal structural members includes the step of forming a pair of sidewall constructions of the modified railcar between the repurposed end sections, wherein each sidewall construction includes a side sill section coupled to one of the side sill sections of each repurposed end section; a top chord section coupled to one of the top chord sections of each repurposed end section, a side wall section extending between the side sill section and the top chord section.

18. The method of modification of a railcar according to claim 12, wherein the aligning and coupling the longitudinal structural members includes the step of providing internal backing bars matching the interior of the center sill sections of each repurposed end section and providing a full depth weld through the center sill section along substantially the full perimeter thereof.

19. The method of modification of a railcar according to claim 18, wherein the aligning and coupling the longitudinal structural members includes the step of providing internal backing bars matching the interior of the side sill sections of each repurposed end section and providing a full depth weld through the side sill section along substantially the full perimeter thereof.

20. The method of modification of a railcar according to claim 18, wherein the aligning and coupling the longitudinal structural members includes the step of providing internal backing bars matching the interior of the top chord sections of each repurposed end section and providing a full depth weld through the top chord section along substantially the full perimeter thereof.
